(19) United States
(12) Patent Application Publication
(10) Pub. No.: US 2007/0295574 A1
(43) Pub. Date: Dec. 27, 2007

(54) WET FRICTION PLATE AND WET MULTI PLATE CLUTCH

(75) Inventors: Ritsuo Toya, Fukuroi-shi (JP); Tsuyoshi Hirayanagi, Fukuroi-shi (JP)

Correspondence Address: SUGHRUE-265550, 2100 PENNSYLVANIA AVE. NW, WASHINGTON, DC, 20037-3213, US

(73) Assignee: NSK-WARNER KABUSHIKI KAISHA, Tokyo (JP)

(21) Appl. No.: 11/765,483

(22) Filed: Jun. 20, 2007

(30) Foreign Application Priority Data
Jun. 22, 2006 (JP) 2006-172179

(51) Int. Cl. F16D 13/00

(52) U.S. Cl. 192/70.14; 192/107 R

(57) ABSTRACT

Friction materials 21 and 22 of different types which differ from each other in terms of a material and a thickness are affixed to respective surfaces of the friction plate 20 and engage with surfaces 31 and 32 of respective separators 30. In the case where the friction materials 21 and 22 are affixed to respective surfaces of the core plate 23 of the fiction plate 20, when the friction materials 21 and 22 are aligned in this sequence along a horizontal direction in a drawing, the surface 31 of the separator plate 30 engages with either of the friction materials 21 and 22, and the surface 32 of the same engages with a remaining friction material. However, when the friction materials 21 and 22 are affixed alternately in different sequence, either of the friction materials 21 and 22 engages with both sides of one separator plate 30.

### BACKGROUND OF THE INVENTION

1. Field of the Invention

The present invention relates to a wet multi plate clutch serving as a clutch for transmission clutch, a lockup clutch, a start clutch, and the like, used in an automatic transmission of a vehicle, as well as to a wet friction plate used in the wet multi plate clutch.

2. Background Art

When a paper friction material is used for the wet multi plate clutch, there are yielded several advantages of: the ability to control transmission torque by means of load exerted on a friction surface, the ability to conduct smooth engagement during transmission by means of the torque, or the like. The paper friction material is widely used in many applications such as a transmission of an automatic transmission, a torque converter, a start clutch, and the like.

The wet multi plate clutch used in an automatic transmission is required to exhibit superior heat resistance and a smooth engagement characteristic.

Among wet friction materials, a friction material having a comparatively-high content of fiber and large in porous characteristic allows immediate elimination of lubricating oil from a friction surface and has a tendency to exhibit a large frictional coefficient at the initial stage of engagement.

In contrast, a friction material having a low content of fiber and containing a large amount of filler has a tendency to exhibit a small friction coefficient at the time of engagement, but a static friction coefficient achieved after completion of engagement tends to be large.

Various characteristics, such as a friction characteristic, heat resistance, a flattening characteristic, and the like, vary according to constituent components or thickness of the wet friction material.

As above, the friction material used in a wet friction plate of a wet multiplate clutch is required to possess different characteristics depending on a location or application where the clutch is used. Therefore, various friction materials are required, but an increase in the number of types of friction materials leads to the disadvantage of an increase in cost. Accordingly, a friction plate including different types of friction materials fixed to a friction surface has been conceived as a solution to the disadvantage, as described in Japanese Patent Unexamined Publication JP-A-2005-330989.

However, affixing different types of friction materials to a single side of the core plate as in the above-described apparatus encounters difficulty in maintaining constant quality of the products, such as alignment of positions to which different friction materials are fixed, uniform thickness of paper, or the like. Further, the number of manufacturing steps is also increased, which causes an increase in production cost

### SUMMARY OF THE INVENTION

In order to solve the problem, the present invention provides a wet friction plate used in a wet multi plate clutch in which a friction material is affixed to both surfaces of each of core plates, wherein friction materials of different types are affixed to the respective surfaces of each of the core plates.

According to the present invention, there is acquired a wet friction plate in which friction materials of different types are affixed to respective front and rear surfaces of each of core plates. As a result, various frictional characteristics can be addressed, and a wet friction plate which is manufactured at low cost and has stable quality can be obtained.

### BRIEF DESCRIPTION OF THE DRAWINGS

FIG. 1 is a front view of a friction plate of the present invention;

FIG. 2 is an explanatory view of a wet multi plate clutch of a first embodiment of the present invention;

FIG. 3 is an explanatory view of a wet multi plate clutch of a second embodiment of the present invention; and

FIG. 4 is an explanatory view of a wet multi plate clutch of a third embodiment of the present invention.

### DETAILED DESCRIPTION OF EXEMPLARY EMBODIMENTS OF THE INVENTION EMBODIMENTS

According to the present invention, there is provided a multi plate clutch in which at least one separator plate and at least one friction plate, in which two different kinds of friction materials are adhered to respective front and rear surfaces of a core plate, are alternately arranged. By combining the separator plate with the friction plate, in which the two different kinds of friction materials are adhered to the respective front and rear surface of the core plate, the same kind of friction surface of the friction plate oppose to both surface of the separator plate. Therefore, thermal balance of both surfaces of the separator plate can be made uniform.

Moreover, use of a highly-heat-resistant friction material enables prevention of occurrence of a heat spot in the separator plate, which is located in the center of the clutch and subjected to sever thermal condition, thus, a clutch having superior heat-resistant can be acquired.

In the friction member, a single friction material may also be applied to different thicknesses over both surfaces of the friction plate. Further, different types of materials having different elastic modulus may also be used as the friction member. In addition, different types of materials having different wear rates may also be used as the friction member.

When different types of materials are used as the friction members, it is better to take into account the following points.

In general, a material having a high content of fibrous component and a material having a low content of fibrous component have hitherto been known as a friction material. The material having a high content of fibrous component has a small friction coefficient but exhibits characteristics of high mechanical strength and high heat resistance. Meanwhile, the material having a low content of fibrous component has a large friction coefficient but exhibits characteristics of low mechanical strength and low heat resistance. Further, the material including a high content of fibrous component causes high frictional engagement in the early stage of engagement, but the material including a low content of fibrous component exhibits a large frictional coefficient after completion of engagement.

Consequently, the amount of fibrous component is a trade-off between the frictional coefficient and the mechanical strength and heat resistance.

In consideration of these characteristics of the friction materials, combined use of these friction materials is useful for obtaining a friction plate or a clutch which exhibits a high frictional coefficient, high mechanical strength and heat resistance, simultaneously.

However, in a case where different types of materials are affixed to a single surface as in the related art when the friction materials are combined with each other, there arises a problem of difficulty in alignment of positions where the materials are to be affixed and a failure to maintain uniform thickness.

Particularly, different types of materials have different coefficients of thermal expansion, respectively. Hence, when the friction materials are heated, a difference arises between the friction materials in terms of thickness. Consequently, the thickness of the friction materials of different types varies between the initial stage of engagement at low temperature and the time of completion of engagement at high temperature. Specifically, irregularities due to uneven thickness are occurred on a single surface.

When such a friction plate is used, partial wear in the friction plate or vibration at the time of engagement of the clutch may be occurred, and thus such the situation is not preferable.

Therefore, different friction materials are affixed to different surfaces of the friction plate as described in the present invention, whereby the problem of uneven thickness induced by the coefficients of thermal expansion can be solved. The reason for this is that, since a single type of friction material is present on a single surface, the thickness of the friction material on the single surface changes as a whole even when the friction material is heated, thereby preventing occurrence of irregularities in the single surface.

There may also be adopted a configuration in which a friction plate is provided with a single ring-shaped friction material. In this case, punching and affixing processes can be simplified.

Alternatively, a configuration in which a friction plate is provided with a plurality of small pieces of friction material may also be adopted. In this case, friction members can be efficiently punched from a sheet-shaped friction material, and enhanced yield is achieved.

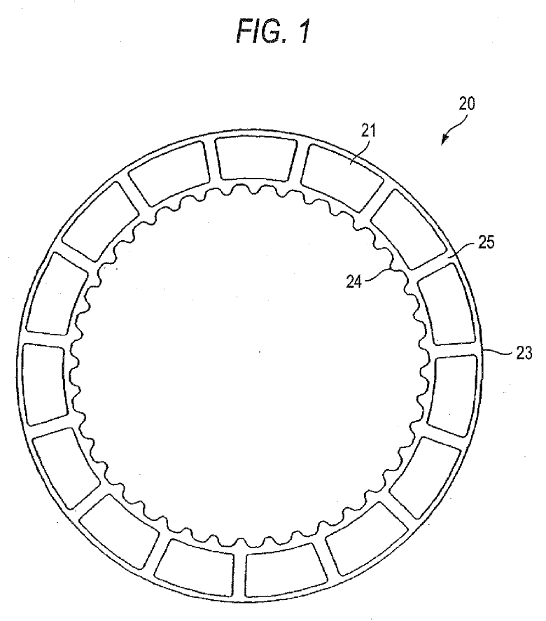

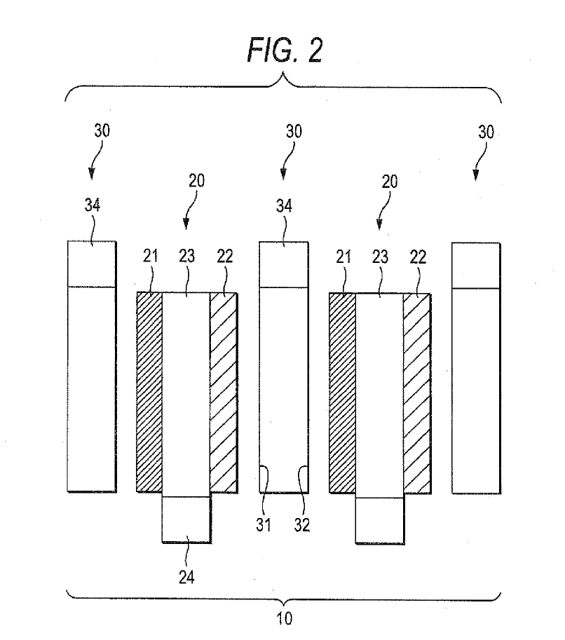

FIG. 1 is a front view showing an example configuration of a friction plate 20. A friction material 21 of one type is affixed to one surface of the core plate 23. Reference numeral 24 designates spline teeth formed on an internal peripheral surface of a core plate 23. Reference numeral 25 designates oil grooves intended for cooling a friction material and stabilizing a friction coefficient. As shown in FIG. 2, a friction material of different type is likewise affixed to a surface on the other side of the core plate shown in FIG. 1.

Embodiments of a clutch formed by incorporation of a plurality of friction plates of the present invention will be described below.

### First Embodiment

FIG. 2 shows a wet multiplate clutch of a first embodiment of the present invention.

FIG. 2 is an explanatory view showing an arrangement 10 of friction plates 20 and separator plates 30 in the multi plate clutch. In the example shown in FIG. 2, a friction material 21 affixed to one surface of the core plate 23 of the friction plate 20 is different in type from a friction material 22 affixed to a surface on the other side (which may also be called a “rear surface”). In accordance with operation conditions, difference between these two types of friction materials may be employed a difference in terms of a constituent component of the material, a plate thickness, or the like, so that the friction materials exhibit various different characteristics, such as a friction characteristic, heat resistance, a flattening characteristic, and others.

As mentioned above, friction materials of different types are affixed to the respective front and rear surfaces of the core plate of the friction plate, so that the present invention can address various frictional characteristics and that a friction plate having stable quality can be provided at low cost. Specifically, provided that a friction material on the left side of the drawing is taken as the friction material 21, and a friction material on the right side of the same is taken as the friction material 22, a left-side surface 31 of the separator plate 30 engages with the friction material 22, and a right-side surface 32 of the same engages with the friction material 21. Thus, the both surfaces of the separator plate 30 engage with the friction materials of different types. Reference numeral 34 designates spline teeth provide along an outer periphery of the separator plate 30.

As mentioned above, if the friction plate of the present invention is used, a material which exhibits great frictional force at the initial stage of engagement and a material which exhibits great frictional force after completion of engagement are combined together. Hence, a clutch, which can exhibit a frictional characteristic of desired magnitude which is constant during the time period from the initial stage of engagement to the time of completion of engagement, can be built.

### Second Embodiment

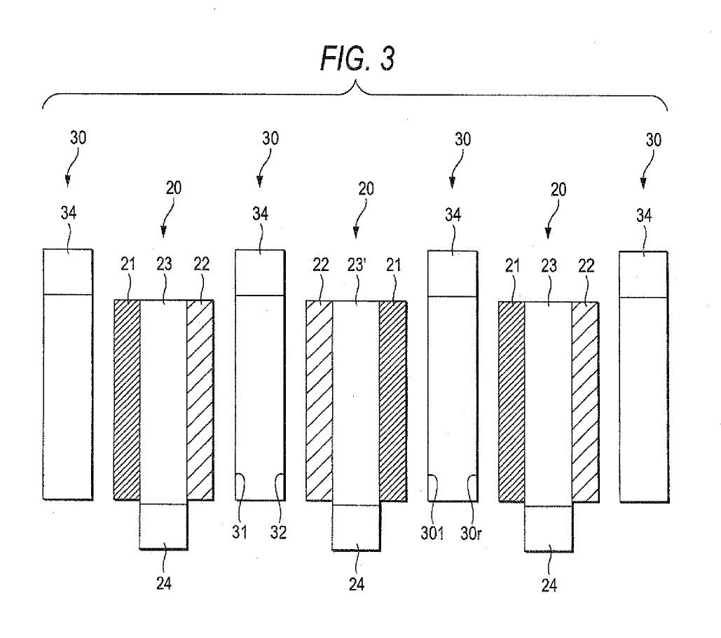

FIG. 3 shows a wet multi plate clutch 10 of a second embodiment of the present invention. In the second embodiment, the number of the friction plates 20 and the number of the separator plates 30 are not limited to those shown in the drawing.

In the embodiment shown in FIG. 3, the two types of friction materials 21 and 22 are affixed to the surfaces of the core plate 20 in such a way that one type of friction material is affixed alternately to either of the surfaces of the core plate and that the other type of friction material is affixed to the remaining surface of the core plate when compared with the case where the two types of friction materials 21 and 22 are affixed in such a way that one type of friction material is always affixed to the surface of the core plate on the same side in the drawing and that the other type of friction material is always affixed to the other surface of the core plate, as shown in FIG. 2. Specifically, when the friction material 21 is affixed to the left-side surface of the leftmost core plate 23 in the drawing, and the friction material 22 is affixed to the other surface of the core plate 23. The friction material 22 is affixed to the left-side surface of a core plate 23′ located on the right side of the core plate 23, and the friction material 21 is affixed to the other surface of the core plate 23′ Both sides of the separator plate 30 sandwiched between the two friction plates are engaged with the friction material of a single type (the friction material 22 of this case).

In the core plate 23 of a friction plate 20 located on the right side of the core plate 23′, the friction materials 21 and 22 are affixed to the same sides where their counterparts are affixed to the leftmost core plate 23. Therefore, surfaces 30l and 30r of the separator plate 30 sandwiched between the core plates 23′ and 23 engage with the friction material 21 of the single type.

According to the present embodiment, both sides of that separator plate 30 are engaged with the friction material 21 of a single type. Since the friction material of a single type exhibits the same heat characteristic, the same frictional heat arises between the separator plate 30 and the friction material 21. Accordingly, both surfaces 30l and 30r of the separator plate 30 are heated to the same temperature.

However, when both surfaces of the separator plate 30 engage with friction materials of different types as in the second embodiment shown in FIG. 2, both surfaces of the separator plate 3 are heated to different temperature by frictional heat. In this case, the higher-temperature side of the separator plate 30 thermally expands greater than the lower-temperature side of the same, thereby deforming the separator plate 30. If the separator plate 30 has become deformed as mentioned above, a change in a characteristic exhibited by the clutch at the time of engagement or a fracture of the clutch will arise undesirably.

Consequently, according to the present embodiment, both sides of the separator plate 30 are heated to the same temperature, and hence deformation of the separator plate 30, which would otherwise be caused by thermal expansion, can be prevented.

### Third Embodiment

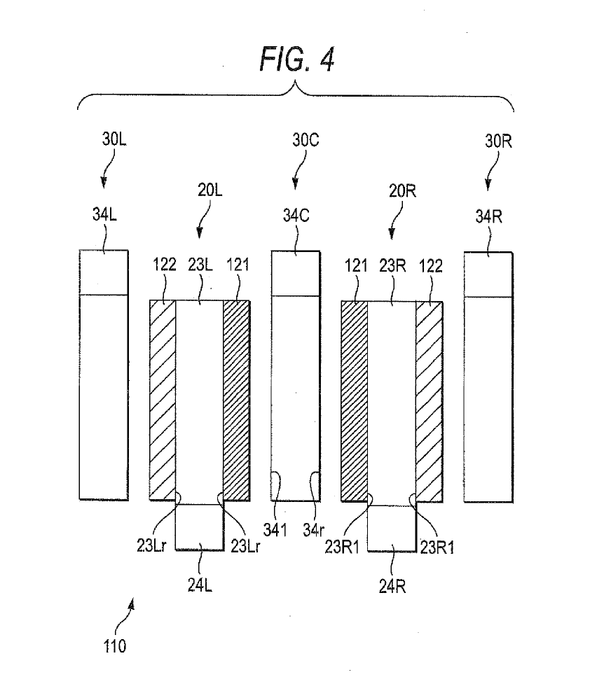

FIG. 4 shows a wet multi plate clutch 110 according to a third embodiment that is a modification of the second embodiment.

The wet multi plate clutch 110 of the third embodiment has two friction plates 20L and 20R; three separator plates 30L, 30C, and 30R; and a friction material 121 which exhibits high heat resistance and high heat radiation and is provided on a surface 23Lr of that friction plate 20L and a surface 23Rl of that friction plate 20R which contact the center separator plate 30c.

A friction material including a large amount of fibrous component is preferably used as a high-heat-radiation friction material for the friction material 121.

In the multi plate clutch using a plurality of friction plates and separator plates, radiation is less likely to arise in a space inside the clutch as in the case of, e.g., the separator plate 30C, and the space tends to become heated to a higher temperature when compared with other locations in the clutch. When the friction material becomes heated, seizing of the separator plate or deterioration of the friction material will arise undesirably.

However, according to the third embodiment, the friction material exhibiting high radiation and high heat resistance is provided in the clutch that is to be heated, thereby effectively preventing occurrence of the above-mentioned problems.

Since the friction material including a large amount of fibrous component usually exhibits a small frictional coefficient, a friction material which includes a small amount of fibrous component but a large amount of filler is preferably provided on the respective surfaces 23Lr and 23Rl of the friction plates in order to compensate for the frictional coefficient. With such a configuration, the clutch can exhibit a high frictional coefficient. The outside of the internal space of the clutch is likely to dissipate heat to peripheral members such as a housing or the like. Even when a friction material which exhibits inferior heat radiation and inferior heat resistance is used in this space, seizing up of the previously-described member or deterioration of the material wilt less likely to take place.

The wet multi plate clutch and the wet friction plate of the present invention have the configurations, such as those mentioned above, and can be manufactured in a comparatively-easy manner, thereby avoiding an increase in cost. Moreover, requests for various heat characteristics and engagement characteristics can be readily met.

While the invention has been described in connection with the exemplary embodiments, it will be obvious to those skilled in the art that various changes and modification may be made therein without departing from the present invention, and it is aimed, therefore, to cover in the appended claim all such changes and modifications as fall within the true spirit and scope of the present invention.

What is claimed is:

1. A friction plate for a wet multi plate clutch comprising:
a core plate having first and second surfaces;
a first friction member provided on the first surfaces; and
a second friction member provided on the second surfaces,
wherein the first friction member is different from the second friction member.

2. The friction plate according to claim 1, wherein
a material of the first friction member differs from that of the second friction member.

3. The friction plate according to claim 1, wherein
thickness of the first friction member differs from that of the second friction member.

4. The friction plate according to claim 1, wherein
friction characteristic of the first friction member differs from that of the second friction member.

5. A wet multi plate clutch comprising:
a plurality of separator plates; and
a plurality of friction plates interposed between the separator plates, each friction plate comprising:
a core plate having a first surface and a second surface;
a first friction member provided on the first surface; and
a second friction member provided on the second surface,
wherein the first friction member differs from the second friction member.

6. The wet multi plate clutch according to claim 5, wherein
the first and second friction members are arranged such that both surfaces of the separator plates oppose the same friction members of the friction plate.

7. The wet multi plate clutch according to claim 5, wherein
frictional coefficient of the second friction member is higher than that of the first friction member.

8. The wet multi plate clutch according to claim 5, wherein
frictional characteristic of the first friction member differs from that of the second friction member.

9. A wet multi plate clutch comprising:
three separator plates; and
two friction plates interposed between the separator plates, respectively, each friction plate including:
a core plate having a first surface and a second surface;
a first friction member provided on the first surface; and
a second friction member provided on the second surface, wherein
the first friction member differs from the second friction member, and
the friction plates are arranged such that the first surface of the core plate opposes the first surface of another core plate.

10. The wet multi plate clutch according to claim 9, wherein
the first friction member has higher heat resistance than the second friction member.

11. The wet multi plate clutch according to claim 9, wherein
frictional coefficient of the second friction member is higher than that of the second friction member.

12. The wet multi plate clutch according to claim 9, wherein
frictional characteristic of the first friction member differs from that of the second friction member.
